(19) United States
(12) Patent Application Publication
(10) Pub. No.: US 2016/0195607 A1
(43) Pub. Date: Jul. 7, 2016

(54) SHORT-RAGNE OBSTACLE DETECTION RADAR USING STEPPED FREQUENCY PULSE TRAIN

(71) Applicant: Radar Obstacle Detection LTD., Rinatya (IL)

(72) Inventors: John Francis Roulston, Edinburgh (GB); Haim Niv, Hod Hasharon (IL); Alon Slapak, Mazor (IL)

(21) Appl. No.: 14/590,107

(22) Filed: Jan. 6, 2015

(51) Int. Cl. G01S 7/28; G01S 7/35; G01S 7/02

(52) U.S. Cl. CPC G01S 7/28; G01S 7/025; G01S 7/026; G01S 7/35

(57) ABSTRACT

A short range detection system, the system may include a transceiver that is configured to: transmit a step frequency pulse train that comprises multiple radio frequency (RF) pulses that are spaced apart from each other and differ from each other by carrier frequency; wherein spectrums of the multiple spaced apart pulses completely fill a frequency range in which multiple carrier frequencies of the multiple pulses reside; receive echoes resulting from a transmission of the step frequency pulse train; generate detection signals that represent the echoes; and a signal processor that is configured to process the detection signals to detect at least one attribute of a target.

### FIELD OF THE INVENTION

The present invention relates to radar systems for short range obstacle detection, and more particularly, to such systems for detecting wires using polarized waves (obstacle warning radar) and for detecting buried objects (ground penetrating radar).

### BACKGROUND

Collisions with obstacles such as suspended wires and point obstacles such as pylons account for a large percentage of severe and fatal helicopter and other aircraft accidents, especially, but not only at bad visibility conditions and adverse weather. The need for a device that would provide adequate warning against such obstacles is well known for aircraft which are required to fly low. These include, but are not limited to medical evacuation (MEDEVAC), search and rescue (S&R) and police helicopters. Other categories of aircraft which require obstacle detection and warning include unmanned air vehicles (UAVs), and transport aircraft.

Prior art sensor systems apparently do not detect wires effectively. These include, for example, millimetric wave radar, laser radar, FLIR and more. These prior art systems are complex, heavy and costly and only achieve a limited success in detecting wires.

PCT patent application publication serial number WO/2013/164811A discloses a system for detecting wires using polarized waves. Basically, this system includes a transmitter for transmitting multi-polarized waves, means for receiving waves reflected off target and means for analyzing the polarization of the reflected waves to detect linearly polarized echoes characteristic of wires.

When the wires are close, say 10's meters, which occurs for example in take-off or landing, detection might suffer from two major problems: one, low range-resolution which might be good enough for long-range detection but insufficient for short-range detection, and two, blind range of the radar, namely, a range in front of the radar at which the radar does not detect wires accurately enough, if at all.

When the objects are very close, say 1's meters, which occurs for example in underground wires, pipes and other objects detection, the short range challenges of obstacle warning radar are even more acute because the total distance of interest is measured in meters and resolutions are measured in 10's of centimeters.

In all radar systems, high resolution implies high bandwidth, which can be obtained, for example, using very short-duration pulses or using coded pulses, that is pulse compression. The former might suffer from low transmitted power for detection, whereas the latter might suffer from large blind range due to separate transmit (Tx) and receive (Rx) functions which requires some transient time between the two functions, especially in monostatic radar with a single shared antenna.

These considerations militate towards ultra-short uncoded pulses. Detection depends on average power, so high duty ratios are favored, but with ultra-short pulses, high duty ratio means high PRF and consequent multiple-time around echo confusion. That is, range ambiguity in multiples of the pulse repetition interval.

The following prior art references provide information about various aspects of the state of the art:
[1] D. Longstaff et. al., Ground penetration radar, U.S. Pat. No. 6,664,914, Dec. 16, 2003.
[2] J. A. Fessler and B. P. Sutton, “Nonuniform Fast Fourier Transforms Using Min-Max Interpolation”, IEEE T-SP, 51(2), pp. 560-574, February 2003.
[3] D. D. Meisel, “Fourier transforms of data sampled at unequal observational intervals”, Astron. J., Vol. 83 (5), pp. 538-545, May, 1978.
[4] D. Potts, G. Steidl, M. Tasche, “Fast Fourier transforms for nonequispaced data: A tutorial” In Modern sampling theory: Mathematics and Applications, pp. 247-270, Birkhauser, Boston, 2001.

### SUMMARY

According to an embodiment of the invention there may be provided a system for short range detection. Short range may refer to few tenths of meters or much shorted range when aiming to detect underground targets. The system may include a transceiver that may be configured to: (a) transmit a step frequency pulse train that may include multiple radio frequency (RF) pulses that may be spaced apart from each other and differ from each other by carrier frequency; wherein spectrums of the multiple spaced apart pulses may or may not completely fill a frequency range in which multiple carrier frequencies of the multiple pulses reside; (b) receive echoes resulting from a transmission of the step frequency pulse train; (c) generate detection signals that represent the echoes; and a signal processor that may be configured to process the detection signals to detect at least one attribute of a target. When the step frequency pulse train is transmitted towards the ground the spectrums of the pulses do not necessarily fill the entire frequency range.

The carrier frequencies of the multiple pulses may be uniformly distributed over the frequency range.

The carrier frequencies of the multiple pulses may be non-uniformly distributed over the frequency range.

The multiple pulses may be of equal duration.

The system wherein at least two pulses of the multiple pulses differ from each other by duration.

The system wherein at least two pulses of the multiple pulses differ from each other by polarization.

The multiple pulses may be of a same polarization.

The system wherein a duty cycle of the step frequency pulse train is lower than ten percent.

The system wherein a duty cycle of the step frequency pulse train exceeds ninety percent.

The transceiver may be airborne.

The transceiver may be configured to transmit the step frequency pulse train towards a ground.

The transceiver may be configured to transmit multiple step frequency pulse trains, wherein each step frequency pulse train may include multiple pulses that may be spaced apart from each other and differ from each other by carrier frequency; wherein spectrums of the multiple spaced apart pulses completely fill the frequency range in which multiple carrier frequencies of the multiple pulses reside; receive echoes resulting from a transmission of the multiple step frequency pulse trains; and generate detection signals that represent the echoes.

At least two pulses of a same order within different step frequency pulse trains differ from each other by at least one parameter selected out of duration, carrier frequency and polarization.

All pulses of a same order within different step frequency pulse trains have a same duration, carrier frequency and polarization.

All pulses of a first step frequency pulse train of the multiple step frequency pulse trains have a first polarization; wherein all pulses of a second step frequency pulse train of the multiple step frequency pulse trains have a second polarization; wherein the second polarization differs from the first polarization.

According to an embodiment of the invention there may be provided a short range detection system, the system may include a transceiver that may be configured to (a) transmit a step frequency continuous wave that may include a sequence of multiple continuous wave segments that differ from each other by carrier frequency; wherein spectrums of the multiple segments completely fill a frequency range in which multiple carrier frequencies of the multiple segments reside; (b) receive echoes resulting from a transmission of the step frequency continuous wave; (c) generate detection signals that represent the echoes; and a signal processor that may be configured to process the detection signals to detect at least one attribute of a target.

The carrier frequencies of the multiple segments may be uniformly distributed over the frequency range.

The carrier frequencies of the multiple segments may be non-uniformly distributed over the frequency range.

The multiple segments may be of equal duration.

At least two segments of the multiple segments differ from each other by duration.

At least two segments of the multiple segments differ from each other by polarization.

The multiple segments may be of a same polarization.

The transceiver is airborne.

The transceiver may be configured to transmit the step frequency continuous wave towards the ground.

The transceiver may be configured to transmit multiple step frequency continuous waves, each step frequency continuous wave may include a sequence of multiple continuous wave segments that differ from each other by carrier frequency; wherein spectrums of the multiple segments completely fill a frequency range in which multiple carrier frequencies of the multiple segments reside; receive echoes resulting from a transmission of the multiple step frequency continuous waves; generate detection signals that represent the echoes; and wherein the signal processor may be configured to process the detection signals to detect at least one attribute of a target. The multiple step frequency continuous waves may be spaced apart (within the time domain) from each other.

At least two segments of a same order within different step frequency continuous waves differ from each other by at least one parameter selected out of duration, carrier frequency and polarization. The same order means the order of appearance within the segment within a step frequency continuous wave. Index n (ranges between 0 and N−1) represents the order.

All segments of a same order within different step frequency continuous waves have a same duration, carrier frequency and polarization.

All pulses of a first step frequency continuous wave of the multiple step frequency continuous waves have a first polarization; wherein all segments a second step frequency continuous wave of the multiple step frequency continuous waves have a second polarization; wherein the second polarization differs from the first polarization.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates pulses of a unique step frequency pulse train according to an embodiment of the invention;

FIG. 2 illustrates a pulses of a unique step frequency pulse train according to another embodiment of the invention;

FIG. 3 illustrates a spectrum of pulses of unique step frequency pulse trains according to various embodiments of the invention;

FIG. 4 illustrates a method according to an embodiment of the invention;

FIG. 5 illustrates a method according to an embodiment of the invention;

FIG. 6 illustrates a receiver, a transmitter, a transmit antenna, an array of receive antennas and a plane wave from a target according to an embodiment of the invention;

FIG. 7 illustrates segments of a unique step frequency continuous wave according to an embodiment of the invention;

FIG. 8 illustrates a method according to an embodiment of the invention; and

FIG. 9 illustrates a system according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method.

Any reference in the specification to a system should be applied mutatis mutandis to a method that may be executed by the system.

According to an embodiment of the invention there is provided a system and method for short range obstacle detection that may solve the mentioned above deficiencies by basing the detection and range measurement cycle on a unique step-frequency pulse train (SFPT) which includes a train of space apart pulses, each pulse of duration τₙ, coherently derived, on different carrier frequency fₙ [009] under some unique constrains related to the duration and the different carrier frequencies. The obstacle detection may also use polarization for distinguishing obstacles such as wires and other objects with noticeable aspect ratio.

According to an embodiment of the invention there is provided a system and method for performing subterranean imaging by basing the detection and range measurement cycle on a unique step frequency continuous wave (SFCW) that includes a continuous sequence of multiple segments, each segment of a duration τₙ, coherently derived, on different carrier frequency fₙ. In the context of subterranean imaging the gating operation that is applied to generate a SFPT has to be a very high bandwidth operation and, therefore, might ruins the advantage of using SFPT. The unique SFCW can suit for subterranean imaging applications because range ambiguity is a non-issue in such applications due to path attenuation.

Unique SFPT

Assume N carrier frequencies f₀, . . . , f_{N-1} distributed over a frequency range F. Index n ranges between 0 and N−1.

The N frequencies might be uniformly distributed over F, in which case there is a constant frequency step Df between fₙ and fₙ₋₁, or non-uniformly over F, in which case fₙ-fₙ₋₁ is not necessarily equal to fₙ₊₁-fₙ.

The unique SFPT includes a train of N space apart pulses, each pulse has a carrier frequency out of the N carrier frequencies f₀, . . . , f_{N-1} and has a bandwidth that is inversely proportional to a duration of the pulse.

The frequency range F should be filled up by the spectrums of N pulses. The spectrum of the n'th pulse has a bandwidth of 1/τₙ which is centered over carrier frequencies fₙ. Otherwise, range measurement attributed to the spectrum over the frequency range F might be ambiguous. In the simplest case, were all of the pulses are equi-duration that is τₙ=τ, and the N carrier frequencies are uniformly distributed over F, it is important that the difference (Df) between two adjacent carrier frequencies fulfills the following equation: (1/τ)≧Df.

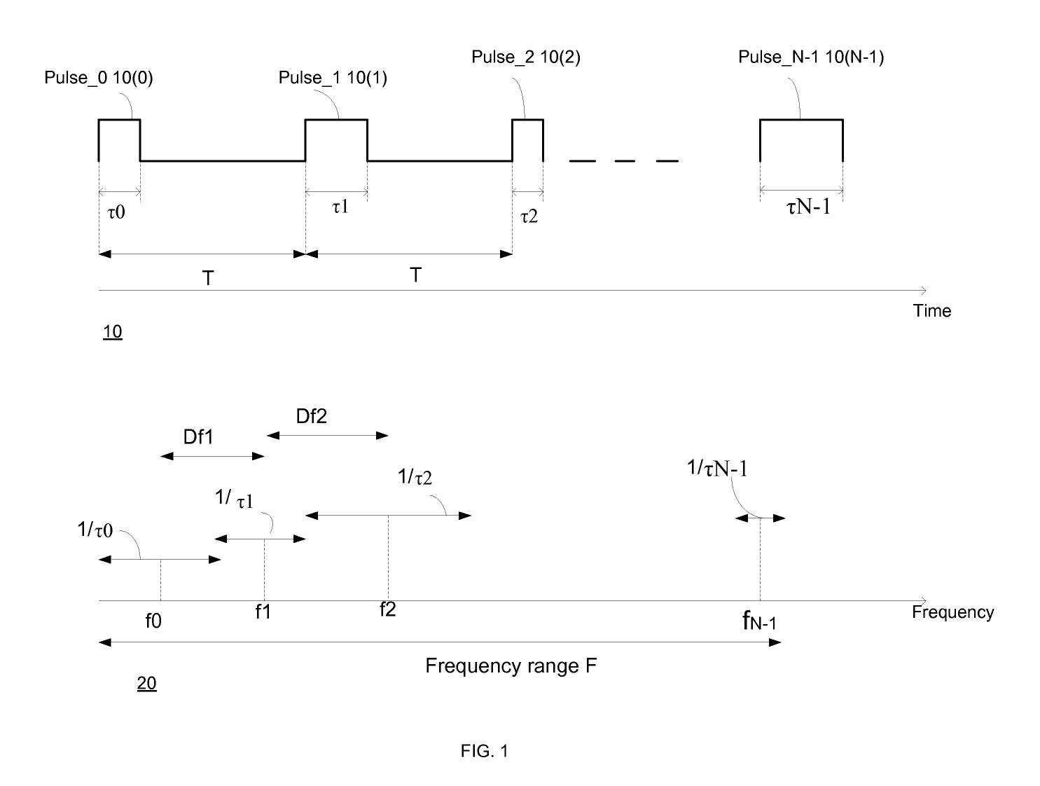

A first example of the unique SFPT is illustrates in the timing diagram 10 and the spectrum 20 FIG. 1.

Timing diagram 10 of FIG. 1 illustrates the unique step-frequency pulse train as including N pulses 10(0)-10(N−1) that are non-uniformly distributed over the frequency range F. The duration (and hence the bandwidth) of pulses 10(0), 10(1), 10(2) and 10(N−1) differ from each other. In addition the carrier frequency and unevenly distributed over frequency range F.

FIG. 1 also illustrates two differences (Df1 and Df2) between the two first pairs of adjacent carrier frequencies (f₁,f₀) and (f₂,f₁), wherein Df1=fₜ-f₀ and Df2=f₂-f₁. Df1 differs from Df2.

Spectrum 20 of FIG. 1 illustrates the full coverage of the frequency range F by the spectrums of the N pulses—such as carrier frequencies f₀, f₁, f₂ till f_{N-1} and their bandwidths 1/τ₀, 1/τ₁, 1/τ₂ till 1/τ_{N-}, wherein the carrier frequency of each pulse is positioned at the center of its spectrum.

It is noted that the spectrums of adjacent pulses may partially overlap or may not overlap at all.

When (1/τ) is less than Df, the spectrum is periodic, sampled at Df. In this case the range measurement attributed to the spectrum will also be periodic sampled at c/(2Df), that is, it is ambiguous unless the spectrum is filled. Constant c is the speed of light.

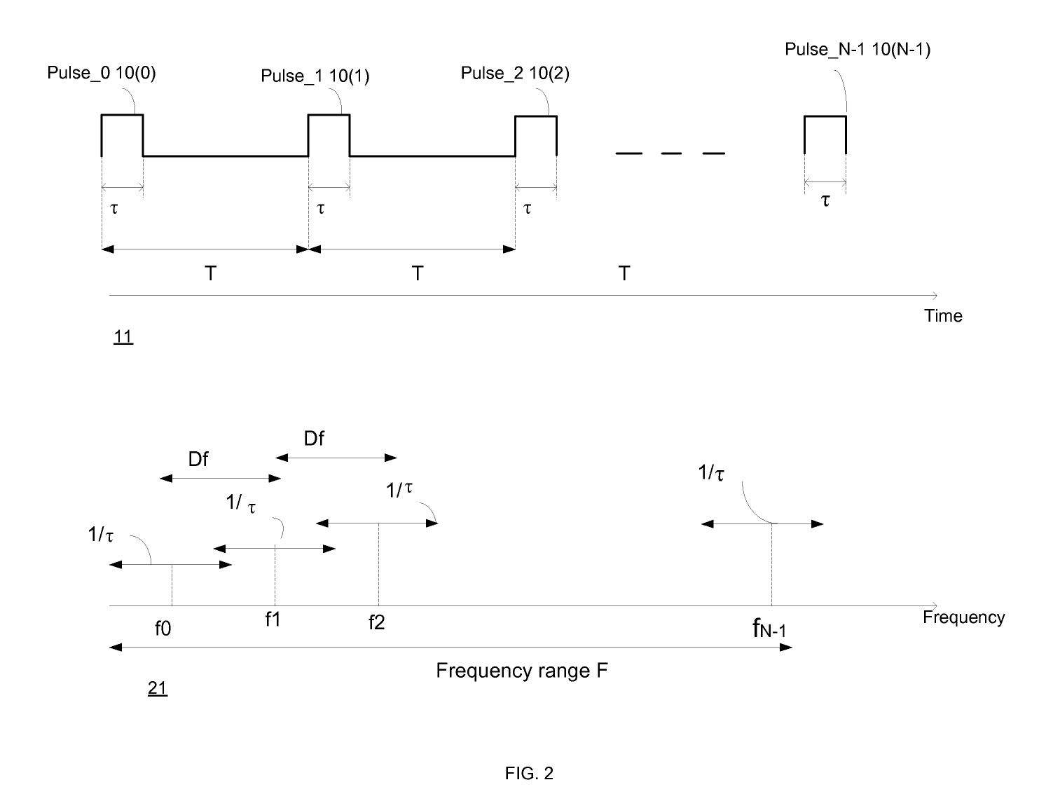

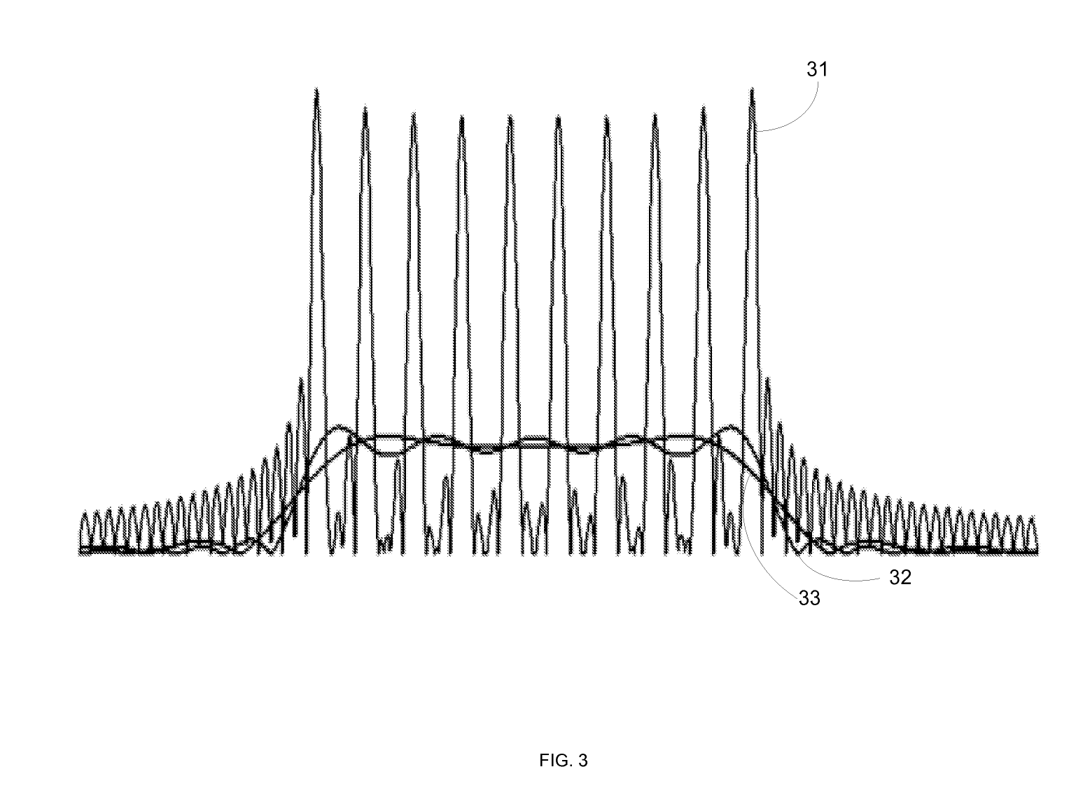

Another example of the unique SFPT is illustrates in the timing diagram 11 and the spectrum 21 FIG. 2 and in spectrums 31,32 and 33 of FIG. 3.

FIG. 2 illustrates a unique SFPT wherein the pulse duration τ is the same for each one of the N pulses and the carrier frequencies are uniformly distributed over frequency range F.

FIG. 3 illustrates three spectrums of three unique SFPTs for N=10 and for three different relationships between Df and τ according to three embodiments of the invention.

Spectrum 31 illustrates a case where there are ten pulses (N=10) that have the same duration τ (and same bandwidth) and their carrier frequencies are evenly distributed over the entire frequency range F. Df*τ=4.

Spectrum 32 illustrates a case where there are ten pulses (N=10) that have the same duration τ (and same bandwidth) and their carrier frequencies are evenly distributed over the entire frequency range F. Df*τ=1.

Spectrum 33 illustrates a case where there are ten pulses (N=10) that have the same duration τ (and same bandwidth) and their carrier frequencies are evenly distributed over the entire frequency range F. Df*τ=0.5.

According to various embodiments of the invention the unique SFPT may include equi-duration pulses with non-uniformly distributed carrier frequencies or different duration pulses with uniformly distributed carrier frequency.

Multiple unique SFPTs may be transmitted in order to detect obstacles.

It is noted that the timing of transmission of the N pulses of a unique SFPT may correspond to the values of the carrier frequencies of the N pulses (as illustrated in FIGS. 1 and 2) but this is not necessarily so.

When multiple unique SFPTs are transmitted—when the schedule of N carrier frequencies of a single unique SFPT is exhausted, N complex samples are available for each range bin. A frequency analysis such as an N-point complex discrete Fourier-Transform (DFT) allows the dR range-bin to be sub-divided into R resolvable elements.

In the uniformly-distributed carrier frequencies case, fast Fourier transform (FFT) algorithm might be used with or without zero-padding and/or windowing so that the range bin dR is sub-divided into shorter ranges each dR′=c/(2·N·Df).

In the non-uniformly distributed carrier frequencies case, non-uniform discrete Fourier transform (NDFT) might be employed. As a generalized approach for non-uniform sampling, NDFT might be used for variable range resolution with focusing about a specific range.

By this means, measurement bandwidth for high resolution is achieved across the unique SFPT whilst the processing bandwidth required at the single pulse level is the same as it would be for a system of normal resolution.

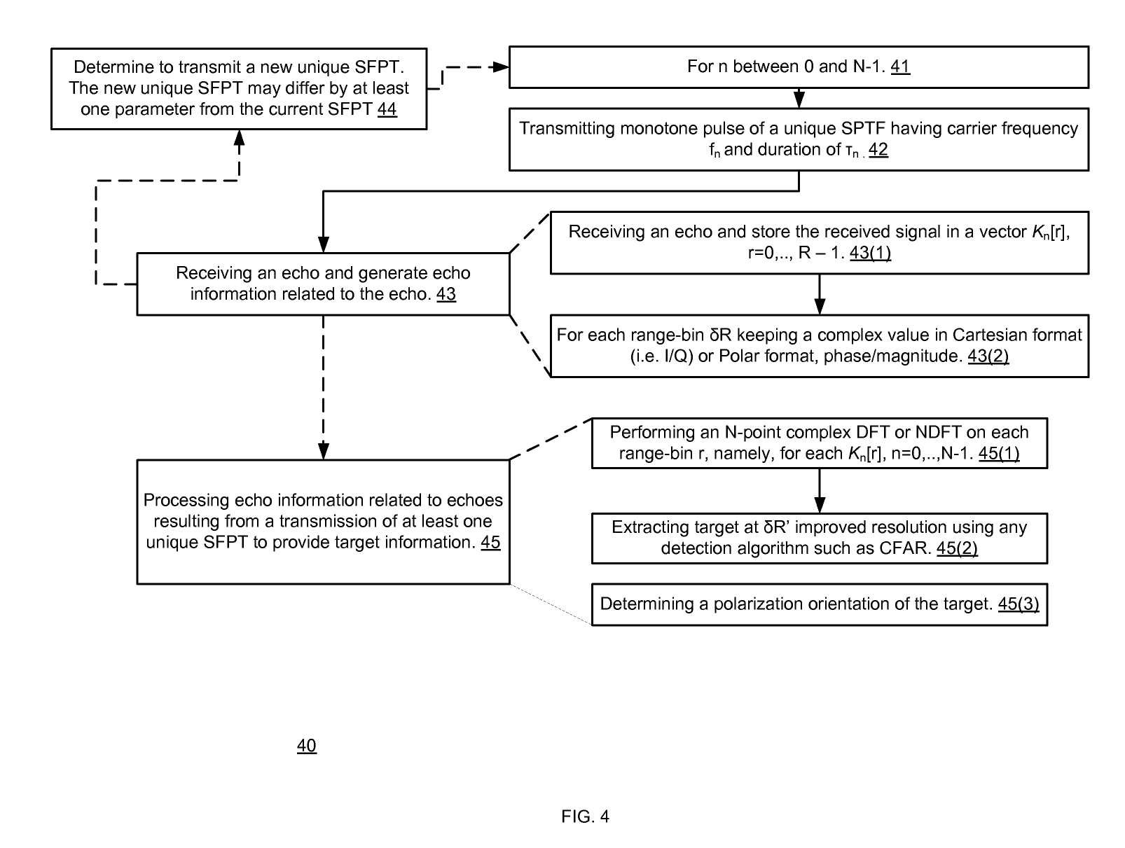

FIG. 4 illustrates method 40 according to an embodiment of the invention.

Method 40 may include a sequence of steps 41, 42, 43 and 45. Step 43 may be followed (after N repetitions) by step 44.

Steps 42 and 43 are repeated N times—so that N pulses of a unique SFPT may be transmitted. The N repetitions are represented by step 41 denoted for n between 0 and N−1. The unique SFPT is unique in the sense that spectrums of the N pulses completely cover the frequency range F in which the carrier frequencies f₀ . . . f_{N-1} are included.

Step 42 includes transmitting a monotone pulse having a carrier frequency of fn and duration of τn.

Step 42 is followed by step 43 of receiving an echo and generating echo information related to the echo.

Step 43 may include, for example step 43(1) of storing the echo in a vector Kₙ[r], r=0, . . . , R−1.

Step 43 may also include step 43(2) that follows step 43(1) and includes keeping, for each range-bin δR, a complex value in Cartesian format (i.e. I/Q) or Polar format, phase/magnitude. This gives a phase modulo 2·pi associated with measurement at the n^{th} carrier frequency.

For example, referring for a first pulse—it is a monotone pulse of duration τ₀ and carrier frequency f₀.

Echoes returned up to the PRI equivalent range, Rₘₐₓ are received and stored in a complex-valued vector denoted, for example by K, of length R=Rₘₐₓ/dR where dR is the resolution in range.

Here Rₘₐₓ=c·T/2, where T is the PRI and 1/T the PRF and c is the velocity of propagation. The resolution, at this stage, is dR=c·t₀/2 where t₀ is the monotone pulse duration.

In other words, the vector K contains R elements indexed by r=0, . . . , R−1, so that each element represents a range bin of length dR. The echoes in each r^{th} range bin, are stored in a complex-valued form, say I and Q components.

The magnitude of the r^{th} element of the vector K reflects the echo intensity from target at range r·dR. The phase of the r^{th} element of the vector K will be 4·pi·(r·dR)/l₀ where l₀ is the wavelength of the carrier frequency f₀, that is, l₀=c/f₀. Since r·dR may be typically many times l₀, the phase which is registered is the residue, modulo 2p, of the real phase.

As indicated by control step 41—steps 42 and 43 are repeated N times until a current unique SFPT is transmitted.

Step 43 may be followed by step 45 after obtaining echo information related to echoes received due to the transmission of one or more unique SFPTs.

Step 45 may include processing echo information related to echoes resulting from a transmission of at least one unique SFPT to provide target information.

Step 45 may include, any step of steps 45(1), 45(2) and 45(3) but may include applying any processing on the echo information.

Step 45(1) may include performing an N-point complex DFT or NDFT on each range-bin r, namely, for each Kₙ[r], n=0, . . . , N−1.

Step 45(1) may be followed by step 45(2) of extracting target at δR′ improved resolution using any detection algorithm such as CFAR.

Step 45(3) may include determining a polarization orientation of a target (that returned an echo).

It is noted that the order of the carrier frequencies used is irrelevant, namely, there is no reason why the frequency schedule should be ascending steps. As far as the exercised carrier frequency is registered, the DFT or the NDFT algorithm can be realized to handle any order of the carrier frequencies.

It is further noted that if a frequency is wiped out by interference or any other sort of obstruction such as noise, the effect is minimal if N is large.

A non-limiting example, relating to obstacle warning radar, with equi-duration pulses and uniformly distributed carrier frequencies is as follows:
a. PRI=10 usec.
b. The PRF is 100 kHz. This would normally be range ambiguous at Rₘₐₓ=1.5km but second and multiple time around echoes will be mis-tuned because of the frequency stepping.
c. τ=0.33 msec. This gives a natural single pulse range resolution of 50m and a duty ratio of 0.033, so that if 10W peak power is available, 0.33W mean power is used for detection.
d. Df=3 MHz.
e. N=100.
f. R=100.

In this case the resolution bandwidth is 300 MHz with 0.5m resolving capability. The time to transmit the pulse train is 1 msec and the effect of relative motion over this observation interval has to be considered. For example if the radial motion in the target direction exceeds 50 m/sec (0.5 m/msec.) the method applies range migration resolution steps.

The one hundred samples at each range bin will be padded with zeros to yield a 256 element complex array and the DFT performed using the FFT algorithm. The 50m range bin is interpolated into 256 elements with a true resolution of 0.5m.

The observation interval of 1 msec yields a natural Doppler resolution of 1 kHz.

If better Doppler resolution is desired, the observation time has to be extended. This can be done in a number of ways. One practical way is simply to track the high range resolution target. For example, after 1 second observation time velocity can be established to 0.5 m/sec. the point is that with high range resolution, velocity estimation as derivative of range is very practical.

Employing Polarization Tx-Rx

According to an embodiment of the invention there is provided a method that involves transmitting pulses in different polarizations thereby alternating between a transmission of circularly polarized and linearly polarized waves so as to distinguish targets using the polarization characteristics of the received signals. Thus, method 40 may be repeated multiple times, using different polarization each time. It is noted that method 40 may be modified by adding a step for detecting the polarization orientation of a target. The polarization of the pulses is determined by the transmitter.

For example, using linearly polarized antennas (might be dipole, or slot, or other). A transmitter may power split the unique SFPT to two unique SFPT portions and sent the two unique SFPT portions to two linearly polarized antennas that are orthogonal to each other. If both unique SFPT portions are fed to the linearly polarized antennas with the same phase the result is (ideally) linear polarization with an angle which is a function of gains of the different paths through which the two unique SFPT portions propagate. Introducing a phase difference of ninety degrees between the unique SFPT portions but maintaining a same gain results in a circular polarization. Introducing both a phase shift and a gain shift between the two unique SFPT portions results in an elliptical polarization.

It is further noted that the transmit antenna may include a transmit antenna that is structured to have a single port and emit circular polarization constantly.

The receive antennas and/or components of the receiver 161 (for example filters) may differentiate between different spectral components of the echoes.

According to an embodiment of the invention all pulses of a one unique SFPT are transmitted using a certain polarization and all pulses of the following unique SFPT are transmitted using another polarization. Thus, different groups of pulses of a single unique SFPT are transmitted using different polarizations. A group of pulses of the same polarization may include consecutive and/or non-consecutive pulses.

Once linearly polarized return wave is detected by the system, the system estimates its polarization orientation and transmits linearly-polarized wave with the same angle, denoted hereafter “oriented polarization”, and its counterpart which is ninety degrees perpendicular denoted “Disoriented polarization”. The objective is to receive maximum reflection in the co-oriented polarization and minimum reflection at the cross-orientation polarization.

To fine-tune the estimation of the polarization orientation, the system rotates the transmitted linearly-polarized wave around the estimated angle until the objective is met.

The transmission of pulses may be done in a way that the samples of the received signals are stored in a way that the analysis stage can be done separately on samples belong to the “oriented polarized” transmitted pulses and on samples belong to the “disoriented polarized” transmitted pulses.

This can be done alternately, such that N pulses with “oriented polarization” are transmitted, received and processed to detect targets and their polarization ratio, and then N pulses with “disoriented polarization” are transmitted, received and processed and so forth.

Alternatively, the transceiver may transmit a single pulse with “oriented polarization” followed by a single pulse with “disoriented polarization” and the returns are stored in separate arrays. This is done N times after which two arrays, each contains N vectors of length R are obtained, one for the “oriented polarized” Tx and one for the “disoriented polarized” Tx.

The SFPT analysis is performed on each array separately, and the polarization test uses both arrays.

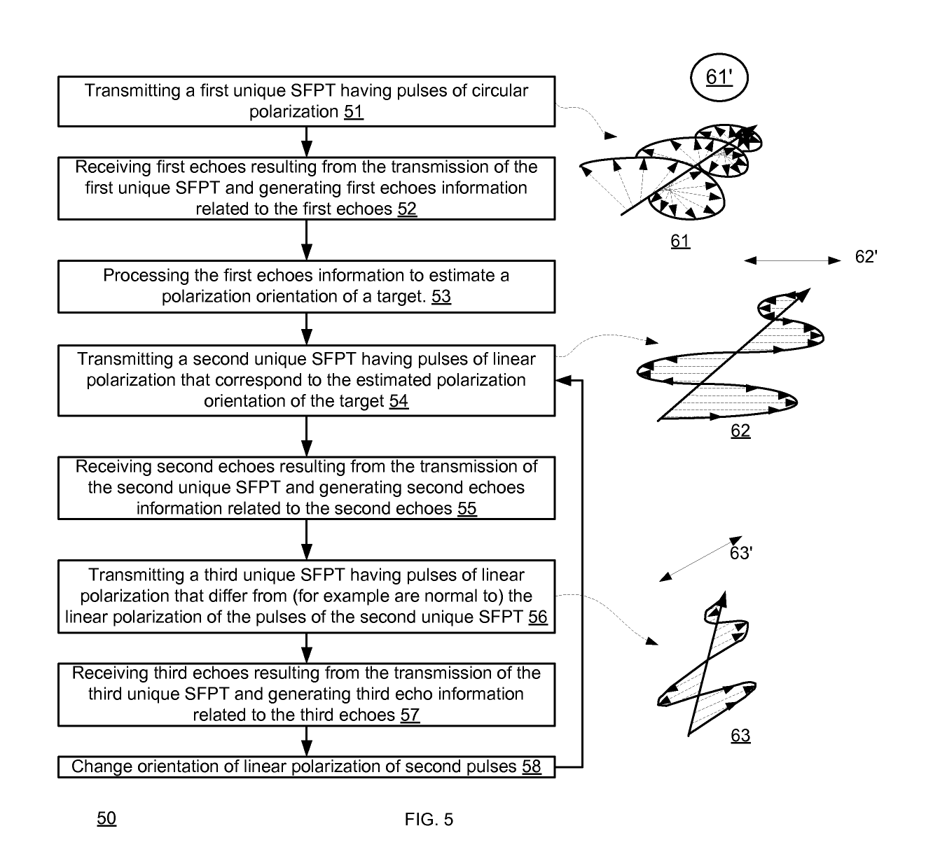

FIG. 5 illustrates method 50 for detecting a polarization orientation of an object (which is a potential obstacle) according to an embodiment of the invention. FIG. 5 also illustrates first pulses 61 of a first unique SFPT of circular polarization (circle 61′ represents the circular polarization), second pulses 62 of a second unique SFPT of a second linear polarization (oriented polarization) reflecting an estimated polarization orientation of a target (arrow 62′ represents the estimated polarization orientation), and third pulses 63 of a third unique SFPT of a third linear polarization (disoriented polarization) that is oriented to the second polarization (arrow 63′).

Method 50 includes a sequence of steps 51, 52, 53, 54, 55, 56, 57. Method 50 may also include step 58 that is followed by step 54.

Step 51 may include transmitting a first unique SFPT having pulses of circular polarization.

Step 52 may include receiving first echoes resulting from the transmission of the first unique SFPT and generating first echoes information related to the first echoes.

Step 53 may include processing the first echoes information to estimate a polarization orientation of a target.

Step 54 may include transmitting a second unique SFPT having pulses of linear polarization that correspond to the estimated polarization orientation of the target.

Step 55 may include receiving second echoes resulting from the transmission of the second unique SFPT and generating second echoes information related to the second echoes.

Step 56 may include Transmitting a third unique SFPT having pulses of linear polarization that differ from (for example are normal to) the linear polarization of the pulses of the second unique SFPT.

Step 57 may include receiving third echoes resulting from the transmission of the third unique SFPT and generating third echo information related to the third echoes.

Step 58 may include change orientation of linear polarization of second pulses. This may be performed during the fine-tuning of the estimation of the polarization orientation of the target. Step 58 may be followed by step 54.

It is noted that step 53 may be unconditionally followed by step 54. It is further noted that step 53 may be followed by step 54 only if step 53 is indicative that the target is endowed with a distinguished linearly-polarized return.

Simultaneous Transmit and Receive

Short range radars can often sacrifice receive energy efficiency and angular resolution and choose to use separate Tx and Rx antennas with broad beams, avoiding scanning. This has the major advantage of reducing the time required to survey the whole field of view. If a target is resolved in range, interferometric means can be used to establish its angular co-ordinates, with accuracy determined by integrated signal to noise ratio.

This common arrangement allows the Tx antenna to be sited so as to achieve isolation from the Rx antenna. Consequently echoes can be received while transmission is in progress, hence reducing the minimum range that can be covered. This can be implemented in any radar, but more easily in SFPT radar. The reason is that coupling between Tx and Rx antennas can never be zero and a figure around −60 dB is about the best that can be relied upon in practice. With 10W peak Tx power, (40 dBm) and saturation level in the LNA above −20 dBm, the system is linear in its RF stages.

The low digitizing rate of the SFPT radar, consequence of the N-times gain in bandwidth, allows a high amplitude resolution ADC to be used with low RF gain and no compromise to noise figure.

The use of the SFPT waveform affords the dynamic range needed to achieve simultaneous transmit and receive operation using separate transmit and receive antennas installed in sensible proximity to each other.

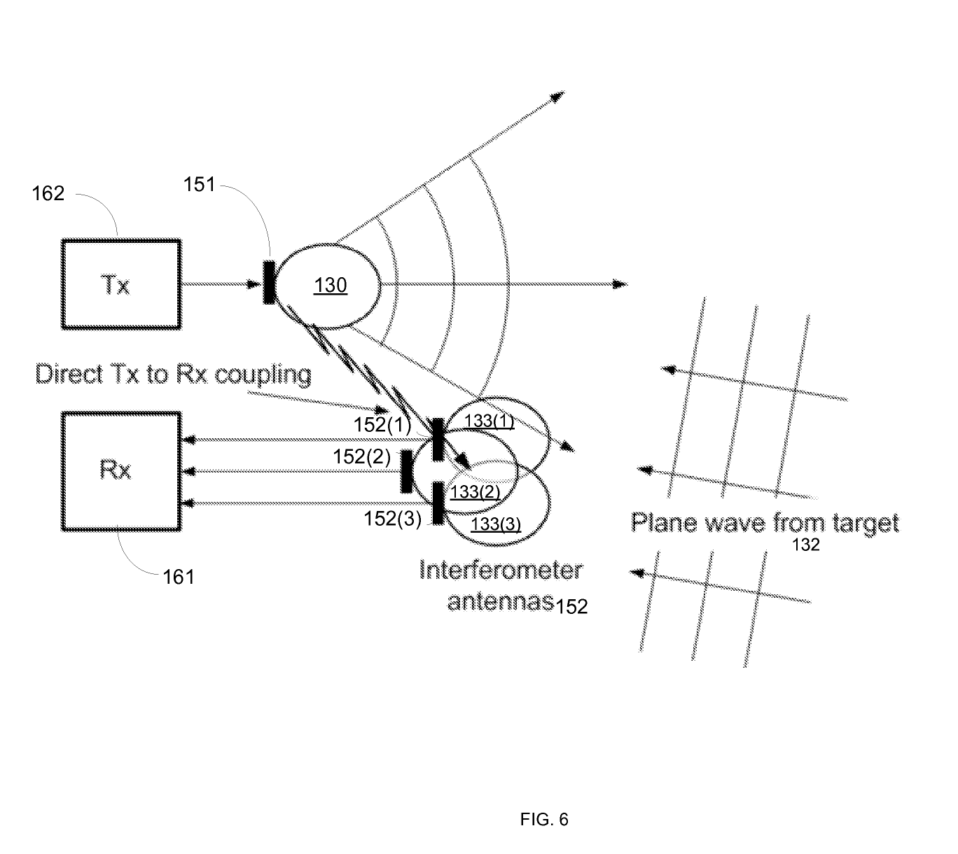

FIG. 6 illustrates a receiver 161, a transmitter 162, a transmit antenna 151, an array 152 of receive antennas 152(1)-152(3) and a plane wave 132 from a target according to an embodiment of the invention.

The arrangement of FIG. 6 is configured to simultaneously transmit unique SFPT and receive echoes. Transmit antenna 151 has lobe 130. Receive antennas 152(1), 152(2) and 152(3) have partially overlapping lobes 133(1), 133(2) and 133(3) respectively. They receive a leakage signal due to an (unwanted) coupling between the transmit antenna 151 and the receive antennas and also receive a plane wave from target 132.

Ground Penetrating Radar

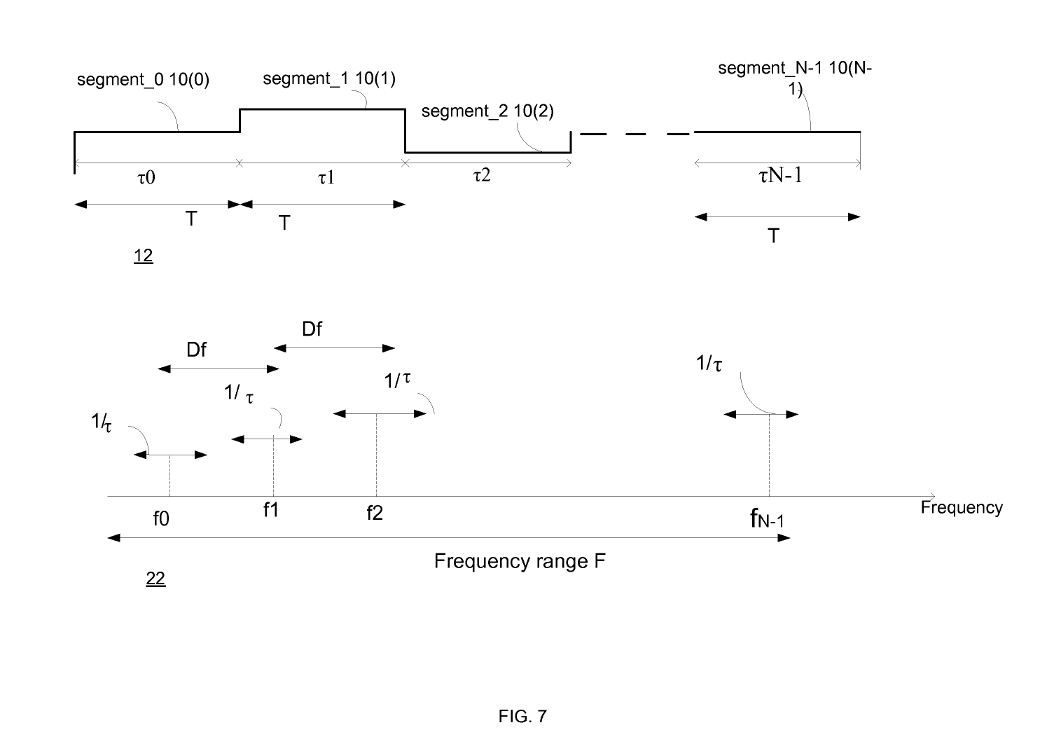

In Ground Penetrating Radar, the constraint that τ·Df≦1 can be relaxed and the sampled spectrum which is shown in FIG. 7 can be used. This is due to the high energy absorption of soil which ensures that ambiguous echoes vanish.

Hence τ can be increased until it approaches the PRI and a quasi CW regime obtained. This means that longer integration time can be used with relaxation in transmitted power for the same detectability. This implies cost and size reduction.

Moreover, since GPR systems must transmit and receive simultaneously and since such systems can rarely have antenna coupling less than −30 dB, the reduction in peak power is needed for linearity. By using effectively CW operation (or quasi-CW operation), such systems can be specified with transmitted peak power in the mW region and integration times around 50 msec.

According to an embodiment of the invention the system may transmit a step-frequency continuous wave (SFCW) that include a continuous sequence of continuous wave segments, each segment has a different carrier wave and spectrums of the multiple spaced apart pulses completely fill a frequency range in which multiple carrier frequencies of the multiple continuous wave segments reside.

A non-limiting example of a SFCW is illustrated in the timing diagram 12 and the spectrum 22 of FIG. 7. The differences in height of the segments of timing diagram are used to differentiate between different segments—this is not indicative of changes in intensity of the segments.

After transmitting N segments of a step frequency continuous wave the transceiver may transmit another step frequency continuous wave. There may be a time gap between these step frequency continuous waves but this is not necessarily so and a time gap may not be introduced between adjacent step frequency continuous waves.

Practical parameters for GPR using SFCW are as follows:
a. PRI, T=1 msec. Pulse energy can be integrated over this interval allowing low power transmission.
b. Measurement cycle, N.T=50 millisecond.
c. P_{TX}=1 milliwatt.
d. Df=10 MHz, implies range ambiguity at 15 meters, but this is of no consequence due to energy absorption in soil.
e. N=50, achieving a resolution bandwidth of (N.Df)=500 MHz, which with reduced propagation velocity in soil implied a range resolution better than 20 cm.

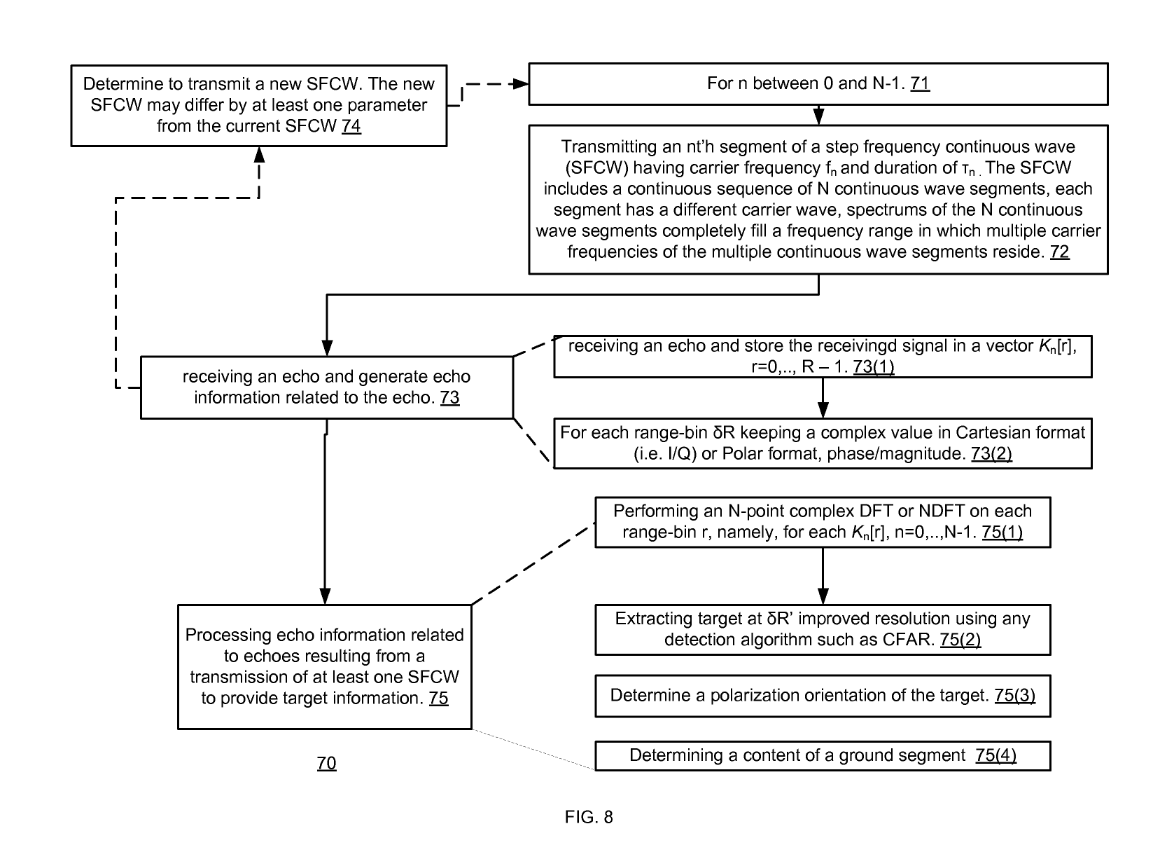

FIG. 8 illustrates method 70 according to an embodiment of the invention. Method 70 includes steps 71, 72, 73, 74 and 75. Step 73 may include stages 73(1) and 73(2). Step 75 may include steps 75(1)-75(4).

Method 70 differs from method 40 of FIG. 4 by transmitting a unique SFCW instead of transmitting a unique SFPT.

For example step 72 may include transmitting an n'th segment of a step frequency continuous wave (SFCW) having carrier frequency fₙ and duration of τₙ. The SFCW includes a continuous sequence of N continuous wave segments, each segment has a different carrier wave. The spectrums of the N continuous wave segments may or may not completely fill a frequency range in which multiple carrier frequencies of the multiple continuous wave segments reside.

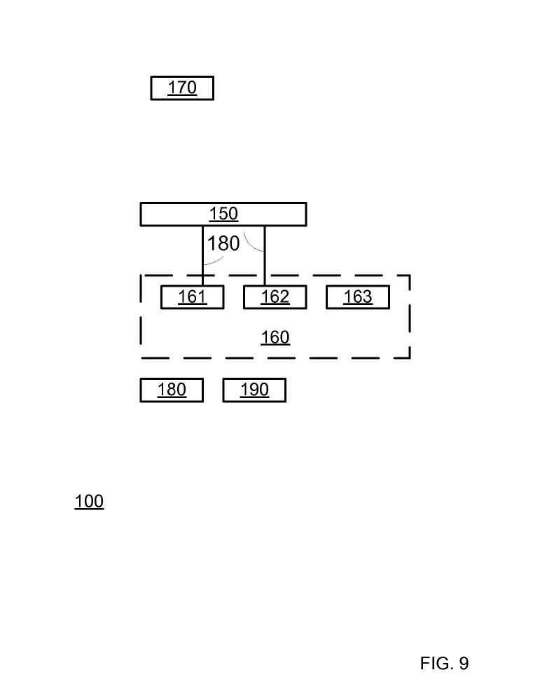

FIG. 9 illustrates a system 100 according to an embodiment of the invention.

The system 100 includes a RF front end 150.

The RF front end 150 can be used for transmitting transmitted RF signals towards the ground 110 and for receiving received RF signals (echoes) from the ground 110.

The RF signals may be one or more unique SFPT and/or be one segments of a SFCW.

It is noted that instead of having a single antenna there may be provided a transmission antenna and a reception antenna.

System 100 also has a portion 160 that may exchange with the RF front end 150 RF signals that may propagate via RF conduits such as RF cable 180. It is noted that the RF cable 180 can be replaced by other types of cable for conveying non-RF signals (for example—intermediate frequency {IF} signals, digital and/or analog signals) and that in this case the RF front end should include a signal converter for converting RF signals to non-RF signals.

It is further noted that portion 160 (or modules of system 100) may be located in other locations. It may, for example, the portion 160 may be located in proximity to the RF front end 150. Yet for another example a receiver 161 and/or a transmitter 162 of the portion 160 may be positioned near the RF front end 150. The components of portion 160 may be distributed between different units be included in a single enclosure.

Portion 160 may include modules such as but not limited to a transmitter 161, a receiver 162 (receiver 161, transmitter 162 and the RF front end 150 may form a transceiver) and a digital processor 163. The receiver 162 may be fed by the transmitter 161 with the transmitted RF signals (or a sample thereof) and this may be used for a local oscillator of the receiver 162.

FIG. 9 also illustrates the system as including a monitor 170 for displaying information about the content of one or more ground region to be excavated.

FIG. 9 also illustrates an antenna location monitor 90 that is illustrated as being connected to bucket 140 and is configured to monitor the location of the antenna that includes the RF front end 150.

The antenna location monitor 190 may be a global positioning system (GPS) based device, an attitude and heading reference system (AHARS) and the like.). It may be integrated within the RF front end 150 or be separated from the RF front end 150. It may transmit location information to radar 160 in a wireless or wire-based manner.

The antenna location monitor 190 may provide location information about the location of the antenna during the receiving of the received RF signals.

The pairing between received RF signals and the location of the antenna during the receiving of the received RF signals may be utilized, by radar 160, to generate a synthetic image of the content of one or more ground regions.

Non limiting examples of SAR radar techniques of airborne systems are illustrated in US patent applications 120100283669 of Discamps, 120140062764 of Reis and 120140285371 of Abatzoglou all being incorporated herein by reference.

The synthetic aperture techniques may process information related to the same ground region—that were taking at different angles and/or different points of time and thus may increase the resolution of the analysis of the content of the ground region.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A short range detection system, the system comprises:
a transceiver that is configured to:
(a) transmit a step frequency pulse train that comprises multiple radio frequency (RF) pulses that are spaced apart from each other and differ from each other by carrier frequency; wherein spectrums of the multiple spaced apart pulses completely fill a frequency range in which multiple carrier frequencies of the multiple pulses reside;
(b) receive echoes resulting from a transmission of the step frequency pulse train;
(c) generate detection signals that represent the echoes; and
a signal processor that is configured to process the detection signals to detect at least one attribute of a target.

2. The system according to claim 1 wherein the carrier frequencies of the multiple pulses are uniformly distributed over the frequency range.

3. The system according to claim 1 wherein the carrier frequencies of the multiple pulses are non-uniformly distributed over the frequency range.

4. The system according to claim 1 wherein the multiple pulses are of equal duration.

5. The system according to claim 1 wherein at least two pulses of the multiple pulses differ from each other by duration.

6. The system according to claim 1 wherein at least two pulses of the multiple pulses differ from each other by polarization.

7. The system according to claim 1 wherein the multiple pulses are of a same polarization.

8. The system according to claim 1 wherein a duty cycle of the step frequency pulse train is lower than ten percent.

9. The system according to claim 1 wherein a duty cycle of the step frequency pulse train exceeds ninety percent.

10. The system according to claim 1 wherein the transceiver is airborne.

11. The system according to claim 1 wherein the transceiver is configured to transmit the step frequency pulse train towards a ground.

12. The system according to claim 1 wherein the transceiver is configured to transmit multiple step frequency pulse trains, wherein each step frequency pulse train comprises multiple pulses that are spaced apart from each other and differ from each other by carrier frequency; wherein spectrums of the multiple spaced apart pulses completely fill the frequency range in which multiple carrier frequencies of the multiple pulses reside; receive echoes resulting from a transmission of the multiple step frequency pulse trains; and generate detection signals that represent the echoes.

13. The system according to claim 12 wherein at least two pulses of a same order within different step frequency pulse trains differ from each other by at least one parameter selected out of duration, carrier frequency and polarization.

14. The system according to claim 12 wherein all pulses of a same order within different step frequency pulse trains have a same duration, carrier frequency and polarization.

15. The system according to claim 12 wherein all pulses of a first step frequency pulse train of the multiple step frequency pulse trains have a first polarization; wherein all pulses of a second step frequency pulse train of the multiple step frequency pulse trains have a second polarization; wherein the second polarization differs from the first polarization.

16. A short range detection system, the system comprises: a transceiver that is configured to: transmit a step frequency continuous wave that comprises a sequence of multiple continuous wave segments that differ from each other by carrier frequency; receive echoes resulting from a transmission of the step frequency continuous wave; generate detection signals that represent the echoes; and a signal processor that is configured to process the detection signals to detect at least one attribute of a target.

17. The system according to claim 16 wherein spectrums of the multiple segments completely fill a frequency range in which multiple carrier frequencies of the multiple segments reside.

18. The system according to claim 16 wherein the carrier frequencies of the multiple segments are uniformly distributed over the frequency range.

19. The system according to claim 16 wherein the carrier frequencies of the multiple segments are non-uniformly distributed over the frequency range.

20. The system according to claim 16 wherein the multiple segments are of equal duration.

21. The system according to claim 16 wherein at least two segments of the multiple segments differ from each other by duration.

22. The system according to claim 16 wherein at least two segments of the multiple segments differ from each other by polarization.

23. The system according to claim 16 wherein the multiple segments are of a same polarization.

24. The system according to claim 16 wherein the transceiver is airborne.

25. The system according to claim 16 wherein the transceiver is configured to transmit the step frequency continuous wave towards the ground.

26. The system according to claim 16 wherein the transceiver is configured to transmit multiple step frequency continuous waves, each step frequency continuous wave comprises a sequence of multiple continuous wave segments that differ from each other by carrier frequency; wherein spectrums of the multiple segments completely fill a frequency range in which multiple carrier frequencies of the multiple segments reside; receive echoes resulting from a transmission of the multiple step frequency continuous waves; generate detection signals that represent the echoes; and wherein the signal processor is configured to process the detection signals to detect at least one attribute of a target.

27. The system according to claim 26 wherein at least two segments of a same order within different step frequency continuous waves differ from each other by at least one parameter selected out of duration, carrier frequency and polarization.

28. The system according to claim 26 wherein all segments of a same order within different step frequency continuous waves have a same duration, carrier frequency and polarization.

29. The system according to claim 26 wherein all pulses of a first step frequency continuous wave of the multiple step frequency continuous waves have a first polarization; wherein all segments a second step frequency continuous wave of the multiple step frequency continuous waves have a second polarization; wherein the second polarization differs from the first polarization.
